(19) United States
(12) Patent Application Publication
(10) Pub. No.: US 2004/0076011 A1
(43) Pub. Date: Apr. 22, 2004

(54) Decorative lamp assembly

(76) Inventors: Chao Yang Chen, Taipei (TW); Yu-Shan Tsai, Taipei (TW)

Correspondence Address: BACON & THOMAS, PLLC, 625 SLATERS LANE, FOURTH FLOOR, ALEXANDRIA, VA, 22314

(21) Appl. No.: 10/274,957

(22) Filed: Oct. 22, 2002

(51) Int. Cl. F21V 11/00

(52) U.S. Cl. 362/351

(57) ABSTRACT

A lamp assembly is disclosed, which has: a lamp holder in a cylindrical-shaped and made of an insulating elastic material, including a circular groove on inner peripheral sidewall of a upper end and an insert hole disposed in the center, and the insert hole has at least one electrical wire therein, wherein the insert hole is designed for a size corresponding lamp to be inserted; a cap being capable of tightly sealing the insert hole of the lamp holder from a lower end of the lamp holder, used for prevent moisture entering into the lamp holder; and a lampshade being a transparent housing, including a opening at its lower end and a neck portion with size corresponding to the inner peripheral sidewall, and the neck portion surface has a plurality of protrusion for wedging into the circular groove of the lamp holder.

### BACKGROUND OF THE INVENTION

1. Field of the Invention

The present invention relates to a decorative lamp assembly and, more particularly, to a decorative lamp assembly which can prevent from moisture.

2. Description of Related Art

According to U.S. Pat. No. 5,414,605, a lampshade needs to employ a rubber seal to mount on a lamp holder. An outward flange located at a lower end of the lampshade is designed to match an inward flange at inter peripheral of the lampshade, to form a sealed space. The rubber seal then is slid into the lamp holder. However, if a total part number of the lamp assembly can be reduced but still provide same functionality, the manufacturing cost can be reduced too. In addition, the outward flange of the lampshade is difficult to manufacture, which will increase the manufacturing cost.

Therefore, it is desirable to provide an improved speech recognition method to mitigate and/or obviate the aforementioned problems.

### SUMMARY OF THE INVENTION

The object of the present invention is to provide a decorative lamp assembly which can prevent from moisture and reduce manufacturing cost.

To achieve the object, the lamp assembly of the present invention includes: a lamp holder in a cylindrical-shaped and made of an insulating elastic material, including a circular groove on inner peripheral sidewall of a upper end and an insert hole disposed in the center, and the insert hole has at least one electrical wire therein, wherein the insert hole is designed for a size corresponding lamp to be inserted; a cap being capable of tightly sealing the insert hole of the lamp holder from a lower end of the lamp holder, used for prevent moisture entering into the lamp holder; and a lampshade being a transparent housing, including a opening at its lower end and a neck portion with size corresponding to the inner peripheral sidewall, and the neck portion surface has a plurality of protrusion for wedging into the circular groove of the lamp holder.

Other objects, advantages, and novel features of the invention will become more apparent from the following detailed description when taken in conjunction with the accompanying drawings.

### BRIEF DESCRIPTION OF THE DRAWINGS

FIG. 1 is an exploded drawing of a lamp assembly of the present invention.

FIG. 2 is a combination drawing of the lamp assembly of the present invention.

### DETAILED DESCRIPTION OF THE PREFERRED EMBODIMENT

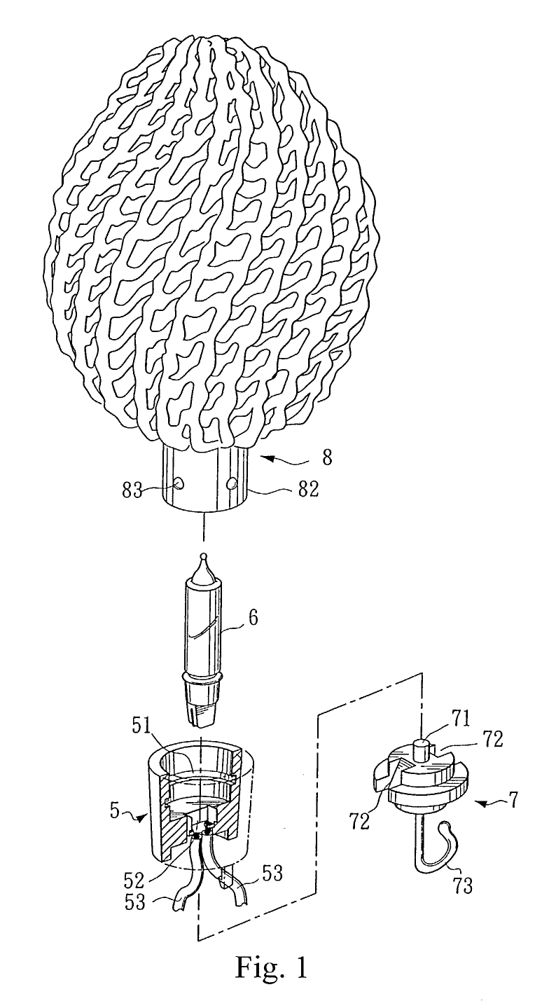

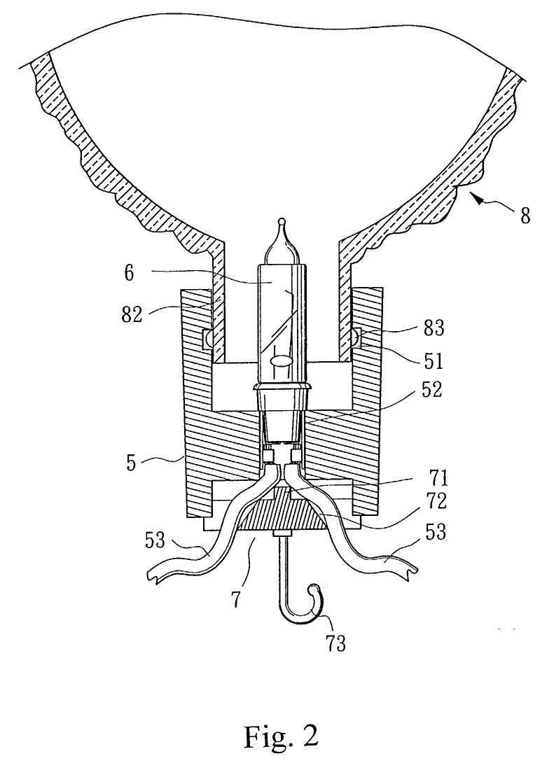

Please refer to FIG. 1 and FIG. 2. FIG. 1 is an exploded drawing of a lamp assembly of the present invention. FIG. 2 is a combination drawing of the lamp assembly of the present invention.

As shown in the drawing, a lamp assembly of the present invention comprises a lamp holder 5, a cap 7, a lamp 6 and a lampshade 8. The lamp holder 5 with a cylindrical-shaped is made of an insulating elastic material such as plastic or rubber. The lamp holder 5 further comprises a circular groove 51 on inner peripheral sidewall of an upper end and an insert hole 52 with a smaller diameter disposed at center. The insert hole 52 has a positive wire 53 and a negative wire 53 respectively with a plug connector at its open end. The insert hole 52 is designed for a size corresponding lamp 6 to be inserted to electronically connect to two electrical wires 53.

The cap 7 has a protruding column 71 positioned on its surface, which can be inserted tightly between the two electrical wires 53 in the sealing the insert hole 32 of the lamp holder 5 to prevent moisture entering into the lamp holder 5. Furthermore, the cap 7 includes two wire tracks 72 placed oppositely around the protruding column 71, for positioning respectively two electrical wires thereof to provide a tighter seal. The cap 7 further has a hook 73 placed at its bottom surface for hanging. The lampshade 8 is made of transparent material such as glass or acrylic. The lampshade 8 has an open 81 at its lower end for the lamp 6 to enter and a neck portion 82 with size corresponding to the inner peripheral sidewall of the lamp holder 5. The surface of the neck portion 82 has four protrusions 83 for wedging into the circular groove 51 of the lamp holder 5.

Comparing to the prior art lamp assembly, the lampshade 8 of the lamp assembly of the present invention needs no rubber seal to be mounted on the lamp holder 5, so a total part number of the lamp assembly can be reduced. Furthermore, the lampshade 8 utilizes the protrusions 83 to wedge into the circular groove 51 of the lamp holder 5. When considering the manufacture process, the protrusion 83 of the present invention is easier to manufacture than the outward flange of the prior art lamp assembly. Therefore, the lamp assembly of the present invention requires no rubber seal and simplifies the manufacture process, which will efficiently reduce the manufacture cost.

Although the present invention has been explained in relation to its preferred embodiment, it is to be understood that many other possible modifications and variations can be made without departing from the scope of the invention as hereinafter claimed.

What is claimed is:

1. A lamp assembly comprising:
a lamp holder with a cylindrical-shaped being made of an insulating elastic material, including a circular groove on inner peripheral sidewall of a upper end and an insert hole disposed at center, and the insert hole has at least one electrical wire inside, wherein the insert hole is designed for a size corresponding lamp to be inserted;
a cap being capable of tightly sealing the insert hole of the lamp holder from a lower end of the lamp holder, to prevent moisture entering into the lamp holder; and
a lampshade being a transparent housing, including an open at its lower end and a neck portion with size corresponding to the inner peripheral sidewall of the lamp holder and the neck portion surface has a plurality of protrusions for wedging into the circular groove of the lamp holder.

2. The lamp assembly as claimed in claim 1, wherein the cap includes at least one wire track for positioning the electrical wire thereof.

3. The lamp assembly as claimed in claim 1, wherein the cap further includes a hook.

4. The lamp assembly as claimed in claim 1, wherein the electrical wire comprises a positive wire and a negative wire respectively with a plug connector at its open end.
